(19) United States
(12) Patent Application Publication
(10) Pub. No.: US 2006/0210791 A1
(43) Pub. Date: Sep. 21, 2006

(54) Metal oxide coated phosphor for plasma display panel and manufacturing method thereof

(76) Inventors: Jae-Soo Yoo, Seoul (KR); Byung-Woo Jung, Seoul (KR); Geun-Young Hong, Seoul (KR); Won-Tae Yoo, Seoul (KR)

Correspondence Address: FLESHNER & KIM, LLP, P.O. BOX 221200, CHANTILLY, VA, 20153, US

(21) Appl. No.: 10/546,214

(22) PCT Filed: Feb. 19, 2004
(86) PCT No.: PCT/KR04/00336

§ 371 Date: Mar. 17, 2006

(30) Foreign Application Priority Data
Feb. 19, 2003 (KR) 1020030010257

(51) Int. Cl. B05D 7/00; B32B 19/00; C09K 11/59

(52) U.S. Cl. 428/336; 427/212; 428/690; 428/702; 428/403

(57) ABSTRACT

The present invention relates to a phosphor for a plasma display panel and a method for producing the same. The phosphor is formed by coating a metallic oxide having a high polarity to a surface of a green phosphor Zn₂SiO₄:Mn with a thickness 10 nm to 0.5 μm. The concentration of a metallic oxide is in a range of 1 to 50 weight % with respect to the green phosphor. According to the green phosphor for the plasma display panel of the present invention, which is made with coating, a metallic oxide having a positive polarity to a surface of a phosphor can be adjusted, thereby enhancing the discharge characteristics when the panel is driven.

### TECHNICAL FIELD

The present invention relates to a phosphor coated with a metal oxide for a plasma display panel and a manufacturing method thereof, and more particularly, to a green phosphor Zn₂SiO₄:Mn for a plasma display panel and a manufacturing method thereof wherein the phosphor has a metallic oxide of a positive polarity coated to its surface to adjust a surface charge of the phosphor in order to improve a discharge characteristic appearing upon driving the plasma display panel.

### BACKGROUND ART

A phosphor is an essential element to drive a variety of display devices and serves to convert energy from an excitation source into energy of a visible ray. An efficiency of the phosphor has been considered as one of important variables determining the efficiency of the display devices efficiency.

An oxide type of a phosphor Zn₂SiO₄:Mn is widely used in a green phosphor for a plasma display panel because it has a good efficiency of a light emission and a good color purity in a high energy of wavelength, e.g., 140 nm˜170 nm under a vacuum. The green phosphor is coated to a barrier rib of the plasma display panel when it is used. However, when the plasma display panel is discharged, the phosphor Zn₂SiO4:Mn represents an overly high surface charge having a negative polarity on its surface due to Si—O having a high negative charge in a compound of the phosphor. As illustrated in FIG. 1 as well as U.S. Pat. No. 5,289,081, the overly high surface charge of the negative polarity does not appears in a red phosphor and a blue phosphor and becomes a fact of deteriorating a wall charge having a positive polarity maintained in the barrier rib. As a result, the surface charge of the negative polarity raises an initiation voltage necessary to drive the plasma display. panel, obstructs an uniform light emission and deteriorates an efficiency of the light emission, which become an obstacle to entirely improve an efficiency of the discharge. Accordingly, in order to change the surface charge of the negative polarity to that of the positive polarity, the green phosphor for the plasma display panel has been substituted with other phosphor materials with a surface charge of a positive polarity or the green phosphor having the negative surface charge has been mixed with the other phosphor materials having the positive surface charge to represent a neutral surface charge. The substituted phosphor materials for the green phosphor may includes YBO₃:Tb, (Ba, Sr, Mg)Al₂O₄:Mn and the like. However, each of the phosphor materials has remarkably different color purity from the green phosphor, and low brightness and heat stability in comparison with the green phosphor. Thus, although the polarity of the surface charge of the green phosphor can be adjusted by mixing the substituted phosphor materials and the green phosphor, the above problem still remains if the mixed ratio of the substituted phosphor materials to the green phosphor is increased.

Accordingly, a research for a novel method capable of adjusting the polarity of the surface charge while maintaining the advantage of the green phosphor has been progressed. Further, a research for a new material and an additional material has been studied.

### DISCLOSURE OF INVENTION

Accordingly, it is an object of the present invention to provide a phosphor for plasma display panel and a manufacturing method thereof wherein the phosphor has a metallic oxide of a positive polarity coated to its surface to adjust a surface charge of the phosphor in order to improve a discharge characteristic appearing upon driving the plasma display panel.

In order to achieve these and other objects of the invention, a metal oxide coated phosphor for plasma display panel according to the present invention is a phosphor for a plasma display panel, wherein the phosphor is formed by coating a metallic oxide having a high polarity to a surface of a green phosphor Zn₂SiO₄:Mn with a thickness of 10 nm to 0.5 μm, a concentration of a metallic ion in the metallic oxide being in a range of 1 to 50 weight % with respect to the green phosphor.

The metallic oxide with the high polarity is selected from a group consisting of magnesium oxide MgO, zinc oxide ZnO, europium oxide Eu₂O₃, lead oxide PbO, aluminum oxide Al₂O₃, and a mixture of two or more the magnesium oxide MgO, the zinc oxide ZnO, the europium oxide Eu₂O₃, the lead oxide PbO and the aluminum oxide Al₂O₃.

A method of manufacturing a phosphor coated with a metallic oxide for use in a plasma display panel, comprising the steps of: (1) manufacturing a precursor by mixing a metallic salt, a solvent and a green phosphor, the metallic salt being a metallic oxide with a high polarity; (2) adjusting pH of the precursor in a range of 7 to 10 by adding a basic material to the precursor; (3) homogeneously dispersing the precursor during the adjustment of the pH or after the adjustment; and (4) filtering a solid material remaining after the step of dispersing and heating the filtered solid material at 100° C. to 600° C. for 10 minutes to 300 minutes.

The metallic salt used in the step of manufacturing the precursor is selected from a group consisting of a nitrate, an acetate, a sulphate or a chloride of magnesium; a nitrate, an acetate, a sulphate or a chloride of zinc; a nitrate, an acetate, a sulphate or a chloride of europium; a nitrate, an acetate, a sulphate or a chloride of an aluminum; a nitrate, an acetate, a sulphate or a chloride of lead; and a mixture of two or more the magnesium, the zinc, the aluminum and the lead.

The solvent used in the step of manufacturing the precursor is selected from a group consisting of a water, a lower alcohol of a carbon-number 1 to 3 and an organic solvent including benzene, toluene, acetone and hexane, and a mixture of two or more the water, the lower alcohol and the organic solvent.

The basic material used in the step of adjusting the pH is selected from a group consisting of an ammonia NH₄OH, an urea, a sodium hydroxide NaOH and a sodium hydrogen phosphate Na₂HPO₄, and a mixture of two or more the ammonia NH₄OH, the urea, the sodium hydroxide NaOH and the sodium hydrogen phosphate Na₂HPO₄.

The step of heating the filtered solid material is performed in a range of 350° C. to 500° C. for 10 minutes to 120 minutes.

### BRIEF DESCRIPTION OF DRAWINGS

These and other objects of the invention will be apparent from the following detailed description of the embodiments of the present invention with reference to the accompanying drawings, in which:

FIG. 1 is a graph representing a surface potential of red, green and blue phosphors for a conventional plasma display panel;

FIG. 2 is a photograph of a green phosphor Zn₂SiO₄:Mn for the plasma display panel taken by a electron microscope;

FIG. 3 is a flow diagram illustrating a method of manufacturing a phosphor coated with a metallic oxide for plasma display panel according to the present invention;

FIG. 4 is a photograph of a phosphor coated with a metallic oxide for plasma display panel according to the present invention, wherein FIG. 4A shows a phosphor coated with a magnesium oxide and FIG. 4B shows a phosphor coated with a zinc oxide;

FIG. 5 is a graph representing a change of a surface charge according to each of metallic oxides coated to the phosphor for plasma display panel according to the present invention; and

FIG. 6 is a graph representing a change of brightness according to a mixed ratio of a magnesium salt to the phosphor coated with a metallic oxide for plasma display panel according to the present invention.

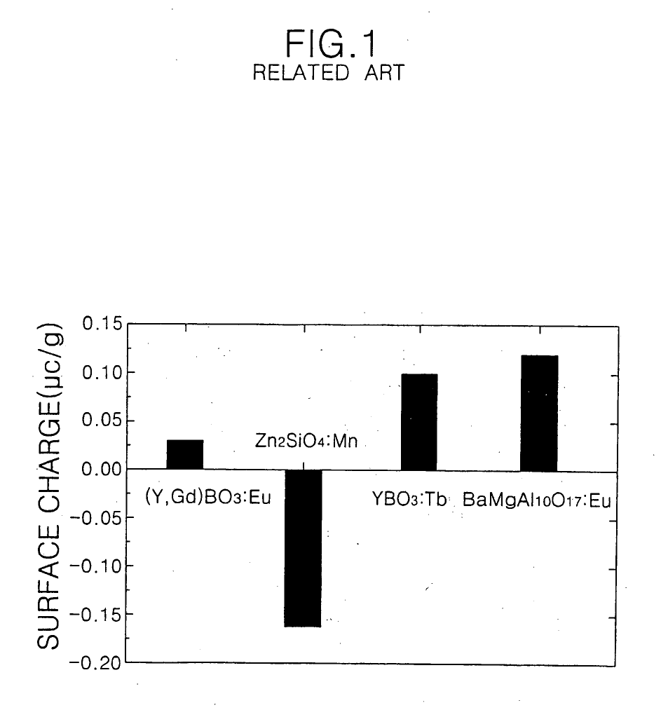

### BEST MODE FOR CARRYING OUT THE INVENTION

Reference will now be made in detail to the preferred embodiments of the present invention, examples of which are illustrated in the accompanying drawings.

A metallic oxide coated phosphor according to the present invention is employed in a phosphor for plasma display panel and is formed by coating a metallic oxide having a high polarity to a surface of a green phosphor Zn₂SiO₄:Mn with a thickness of 10 nm to 10.5 μm. The concentration of a metallic ion in the metallic oxide is in a range of 1 weight % to 50 weight % with respect to the green phosphor.

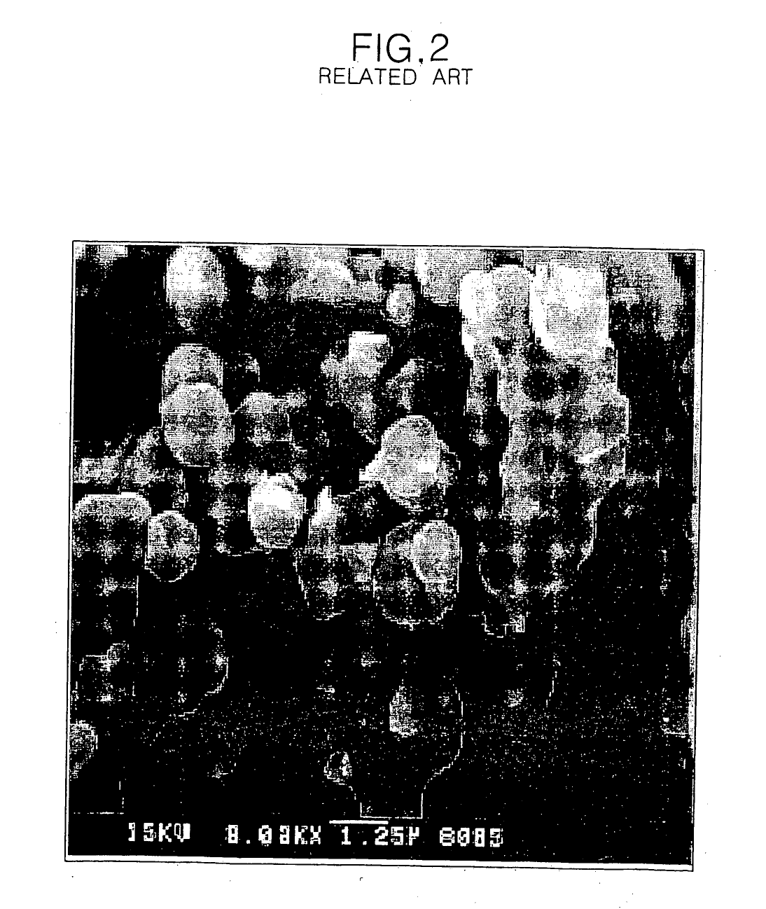

First of all, the phosphor used to coat with the metallic oxide is a green phosphor Zn₂SiO₄:Mn for a plasma display panel. The particles of the green phosphor are distributed in a range of 1 μm to 0.5 μm in their sizes which are shown in FIG. 2 captured by a scanning electron microscope. The metallic oxide to be coated to the phosphor is selected to have a high positive polarity. The metallic oxide with the high positive polarity is selected from a group consisting of magnesium oxide Mgo, zinc oxide ZnO, europium oxide Eu₂O₃, lead oxide PbO and aluminum oxide Al₂O₃, and a mixture of two or more the magnesium oxide Mgo, the zinc oxide ZnO, the europium oxide Eu₂O₃, the lead oxide PbO and the aluminum oxide Al₂O₃. Other metallic oxides besides the metallic oxides as described above may be selected for transiting the polarity of the phosphor. However, it is improper because an additional quantity to be contained to the phosphor may be increased. In order to coat the selected metallic oxide to the surface of the green phosphor, the selected metallic oxide was dissolved to ion state in a solvent such as distilled water. Table 1 shows a metallic salt of the metallic ion having a positive polarity. At this time, the solvent may be selected from a group consisting of a water, a lower alcohol with a carbon-number 1 to 3, and an organic solvent such as benzene, toluene, acetone and hexane, and a mixture of two or more the water, the lower alcohol and the organic solvent.

TABLE 1

| | | Metallic salt | | | |
|---|---|---|---|---|---|
| Classification | | nitrate | acetate | vitriol | chloride |
| Metallic ion | Mg | Mg(NO₃)₂.6H₂O | (CH₃COO)₂Mg.4H₂O | MgSO₄.7H₂O | MgCl₂.6H₂O |
| | Zn | Zn(NO₃)₂.6H₂O | (CH₃COO)₂Zn.2H₂O | ZnSO₄.7H₂O | ZnCl₂ |
| | Eu | Eu(NO₃)₃.XH₂O | (CH₃COO)₃Eu.XH₂O | Eu₂(SO₄)₃. | EuCl₃.6H₂O |
| | | | | XH₂O | |
| | Al | Al(NO₃)₃.9H₂O | (CH₃COO)₂AlOH | Al₂(SO₄)₃. | AlCl₃.6H₂O |
| | | | | XH₂O | |
| | Pb | Pb(NO₃)₂ | (CH₃COO)₂Pb.3H₂O | PbSO₄ | PbCl₂ |

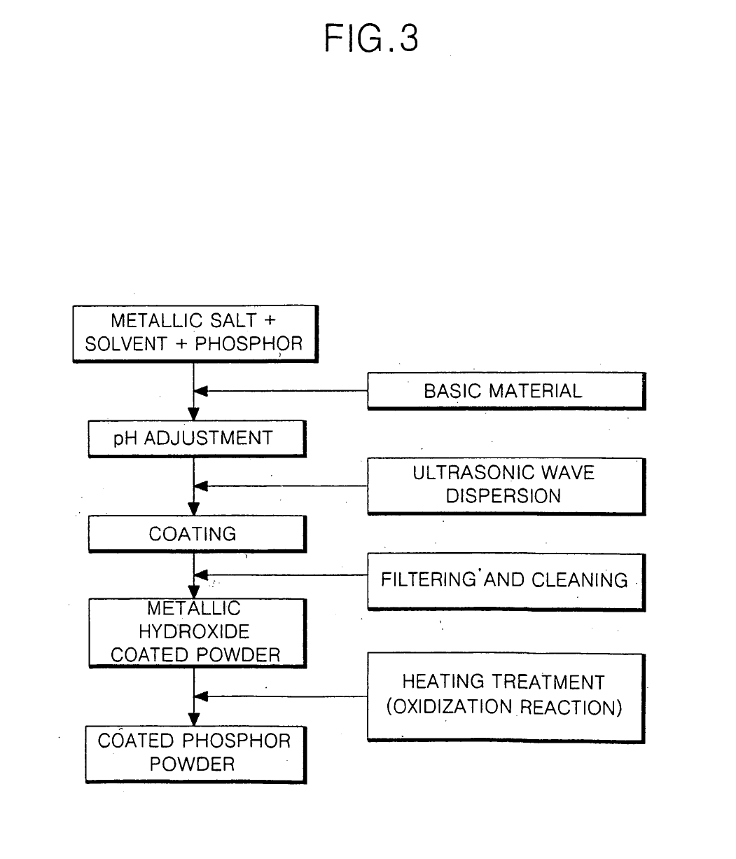

The concentration of the metallic ion the positive polarity was modulated in a rage of 1 weight % to 50 weight % with respect to the green phosphor Zn₂SiO₄:Mn. The green phosphor was added in a solution with the metallic ion dissolved therein and the solution was dispersed by using an ultrasonic wave. At the same time, pH of the solution was adjusted in order to derive a reaction of the metallic ion to a metallic hydroxide and to coat it to the phosphor. A basic material used to adjust the pH may be selected from a group consisting of an ammonia NH₄OH, an urea, a sodium hydroxide NaOH and an sodium hydrogen phosphate Na₂HPO₄, and a mixture of two or more the ammonia NH₄OH, the urea, the sodium hydroxide NaOH and the sodium hydrogen phosphate Na₂HPO₄. At an early stage, the pH of the solution was in a range of 1 to 6.5 in accordance with a kind and a quantity of the metallic ions. However, the pH of the solution adjusted by adding the basic material was changed up to 7 to 10. It was observed that the metallic ion was begun to deposit while changing into the hydroxide at 8 of the pH and the deposition was continued up to about 10 of the pH. After the reaction of the metallic ion to the hydroxide by the adjustment of the pH, there coexisted a metallic hydroxide coated phosphor, a residual metallic ion, which has not been reacted to the metallic hydroxide, and a residual metallic hydroxide, which has not been coated to the phosphor among the metal hydroxide in the solution. Among these, in order to remove the residual non-reacted metallic ion and the residual non-coated metallic hydroxide, the metallic hydroxide coated phosphor was separated from the solution by using a filter to obtain a powder of the metallic hydroxide coated phosphor. The powder was cleaned in pure water and then collected. In order to oxidize the metallic hydroxide into the metallic oxide, the powder coated with the metallic hydroxide was subjected to a heat treatment under a high pressure. The oxidation was performed by heating the powder coated with the metallic hydroxide at 100° C. to 600° C. for 10 minutes to 300 minutes. However, the phosphor itself may be oxidized at the temperature over 100° C. to 600° C. to bring about an adverse effect. Thus, the temperature over 100° C. to 600° C. was precluded. Finally, the phosphor coated with the metallic oxide was obtained through the coating process as set forth above, which is illustrated in FIG. 3.

A method of manufacturing the phosphor coated with the metallic oxide for the plasma display panel according to the present invention includes the steps of: (1) manufacturing a precursor by mixing a metallic salt, a solvent and a green phosphor, the metallic salt being a raw material of the metallic oxide with a high polarity; (2) adjusting pH of the precursor in a range of 7 to 10 by adding a basic material to the precursor; (3) homogeneously dispersing the precursor during the adjustment of the pH or, thereafter; and (4) filtering a solid material remaining after the step of dispersing and heating the filtered solid material at 100° C. to 600° C. for 10 minutes to 300 minutes.

In the step of manufacturing the precursor, a metallic salt is mixed with the green phosphor in advance so as to coat the metallic oxide to a surface of the green phosphor before being transit the metallic salt into the metallic oxide by the adjustment of pH. The step of manufacturing the precursor is to manufacture the precursor by mixing the metallic salt that is a raw material of the metallic oxide with a high positive polarity, the solvent and the green phosphor. The metallic salt used in the step of manufacturing the precursor is selected from a group consisting of a nitrate, an acetate, a sulphate or a chloride of magnesium; a nitrate, an acetate, a vitriol or a chloride of zinc; a nitrate, an acetate, a sulphate, or a chloride of europium; a nitrate, an acetate, a sulphate or a chloride of aluminum; a nitrate, an acetate, a sulphate or a chloride of lead; and a mixture of two or more the the magnesium, the zinc, the aluminum and the lead. Also, a solvent used in the step of manufacturing the precursor is selected from a group consisting of a water, a lower alcohol of a carbon-number 1 to 3, and an organic solvent such as benzene, toluene, acetone, hexane and the like, and a mixture of two or more the water, the lower alcohol and the organic solvent.

Subsequently, a basic material is added to the precursor to adjust pH in a range of 7 to 9. At this time, a positive ion of the metallic salt is transited into a hydroxide by the adjustment of pH and then is deposited. In the step of adjusting pH, the basic material used to adjust the pH may be selected from a group consisting of am ammonia NH₄OH, an urea, a sodium hydroxide NaOH and a sodium hydrogen phosphate Na₂HPO₄, and a mixture of two or more the ammonia NH₄OH, the urea, the sodium hydroxide NaOH and the sodium hydrogen phosphate Na₂HPO₄.

Continuously, during the adjustment of pH of the precursor or thereafter, the step of homogeneously dispersing the precursor is performed. It is preferable that the step of dispersing the precursor is performed using an ultrasonic wave.

Thereafter, after filtering the residual of a solid state, the filtered material of the solid state is heated at 100° C. to 600° C. for 10 minutes to 300 minutes, preferably, at 350° C. to 500° C. for 10 minutes to 120 minutes, thereby obtaining the phosphor coated with the metallic oxide, which will then be used for the plasma display panel.

Hereinafter, preferred examples and comparison example of the present invention will be described as follows.

It should be noted that the following examples are used for exemplifying the present invention and are not limited thereto.

### EXAMPLE 1

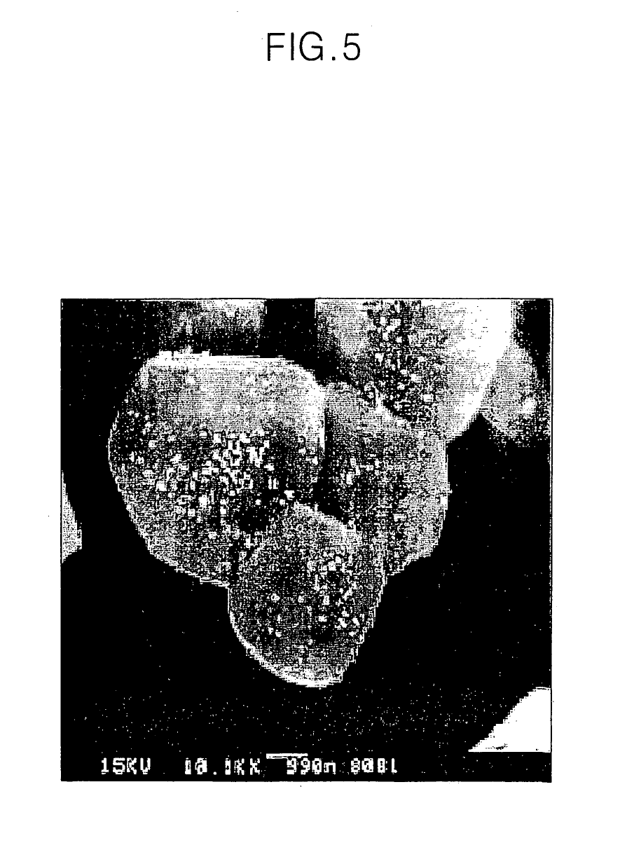

In other to coat a zinc oxide which is one of metallic oxides with a positive polarity, a nitrate of 0.069 g of the zinc serving as a metallic salt of the zinc oxide along with a green phosphor Zn₂SiO₄:Mn of 1 g was dissolved in a pure water and was agitated to obtain a precursor. The pure water used as a solvent to agitate a solution was 0.15 l. In order to react the metallic salt of the precursor, an ammonia of a basic material was added to the precursor and pH of the precursor was adjusted to 7.9 to perform the reaction of the metallic salt to a metallic hydroxide. While adjusting the pH of the precursor by adding the basic material, the materials contained in the precursor was uniformly dispersed by using an ultrasonic wave for 40 minutes. A powder remaining in the solution after the reaction was separated from the other residuals by using a filter and then the powder was cleaned. After the cleaning the powder, the powder was heated at 300° C. for one hour to induce the reaction of the metallic salt to the metallic oxide so that the powder was coated with to obtain the phosphor coated with the metallic oxide. FIG. 5 illustrates the change of a surface charge in the obtained phosphor.

### EXAMPLE 2

The example 2 was performed using the processes identical to those of the example 1 except that a nitrate of 0.189 g of magnesium instead of the nitrate of the zinc was used and pH was adjusted to 8.4.

### EXAMPLE 3

The example 3 was performed using the processes identical to those of the example 1 except that a nitrate of 0.041 g of a lead instead of the nitrate of the zinc was used and the pH was adjusted to 9.2.

### EXAMPLE 4

The example 4 was performed using the processes identical to those of the example 1 except that a nitrate of 0.085 g of aluminum instead of the nitrate of the zinc was used and the pH was adjusted to 8.71.

### EXAMPLE 5

The example 5 was performed using the processes identical to those of the example 1 except that a nitrate of 0.066 g of magnesium instead of the nitrate of the zinc was used and the pH was adjusted to 7.7.

### EXAMPLE 6

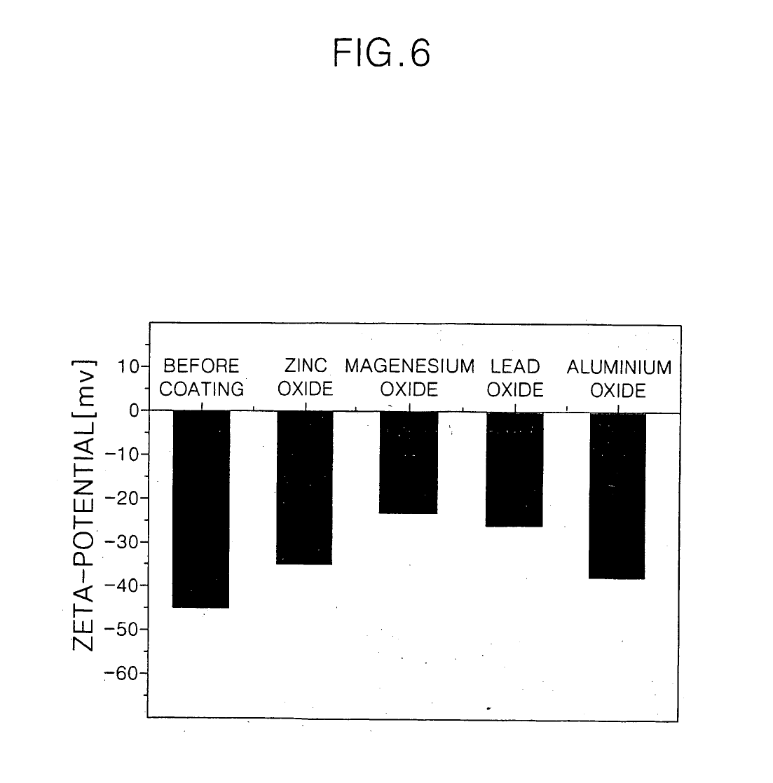

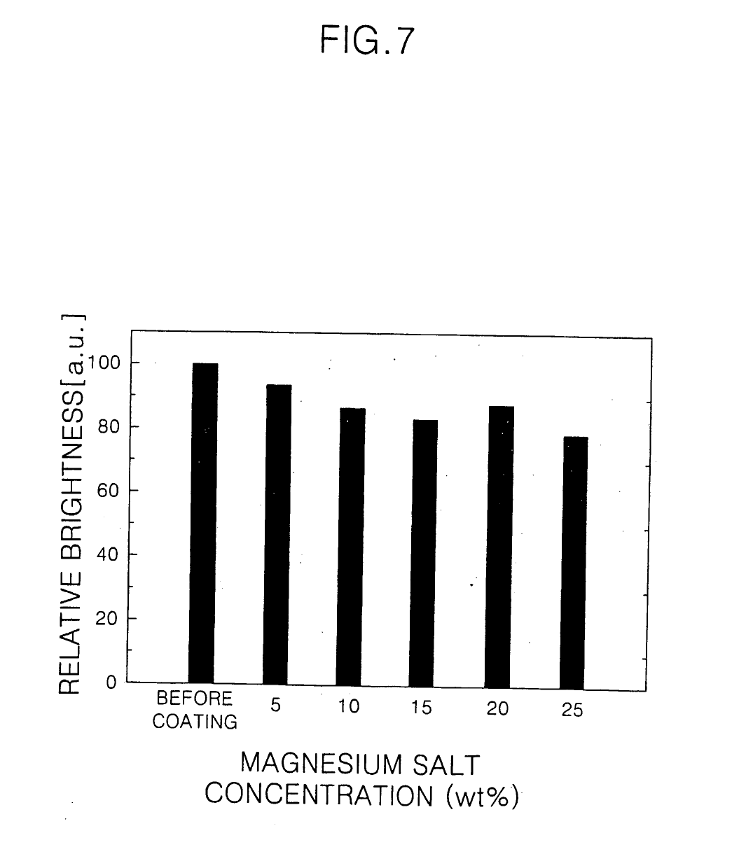

The example 6 was performed using the processes identical to those of the example 1 except that a nitrate of magnesium instead of the nitrate of the zinc was used and the pH was adjusted to 8.4, wherein the quantity of the magnesium was 0.315 g, 0.63 g, 0.954 g, 1.26 g and 1.575 g so that the concentration of the magnesium became 5 weight %, 10 weight %, 15 weight %, 20 weight % and 25 weight %, respectively. As a result, there was observed a change of brightness. The change of the brightness with respect to the concentration of the magnesium is illustrated in FIG. 6.

### COMPARISON EXAMPLE

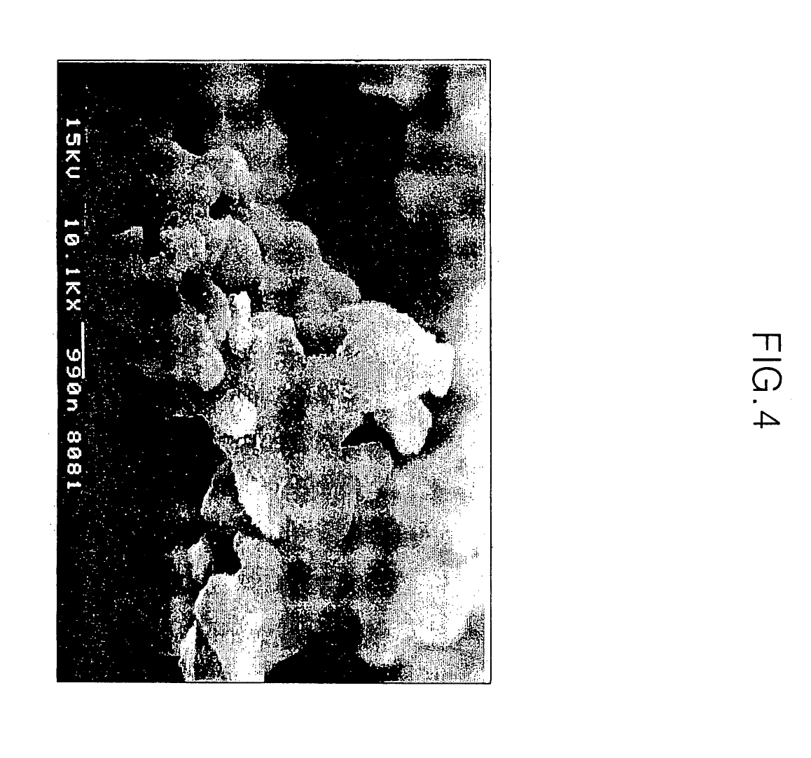

FIG. 4 illustrates the phosphor coated with the magnesium oxide (see, Example 2, FIG. 4A) and the phosphor coated with the zinc oxide (see, Example 1, FIG. 4B) observed through the use of a SEM(Scanning Electron Microscope. As shown in FIG. 4, it can be observed that the metallic oxides dedicated to coat the phosphor in accordance with the present invention have several hundreds nm and less, preferably, 50 nm and less in sizes of their particles that are uniformly coated and distributed. Further, it can be known that the particles of the magnesium oxide rather than those of the zinc oxide are uniformly coated to the particulars of the phosphor.

In addition, a zeta-potential was measured using a Zeta-Potential analyzer in order to verify the change of the surface charge of the particulars due to the coating of the metallic oxides. As shown in FIG. 5, it was observed that the surface charge of the phosphor was decreased by more than at least 30% in a case that the metallic salt added for coating the metallic oxide was 3 weight % with respect to the powder of the phosphor than in a case that none of the metallic salt was coated. Especially, it was known that the negative polarity of the surface charge was transited to the positive polarity by more than 50% when MgO and ZnO were used as the metallic oxide.

Meanwhile, the surface charge of the phosphor may be differentiated by the amount of the metallic oxide to be coated. And thus, the degree of the change of the surface charge was observed while adjusting both of the quantity of the metallic oxide to be coated and the quantity of the metallic salt to be added. The resultant is represented in FIG. 6, wherein the magnesium salt being added was adjusted from 1 weight % to 50 weight %. As can be seen from FIG. 6, as the concentration of the metallic salt became higher, more particles of the metallic oxide became coated to the phosphor. However, it was observed that relatively large and uneven particles of the magnesium salt were coated to the particles of the phosphor in a case that the magnesium salt was over 25 weight %, resulting in a deterioration of an emission property of a brightness. It was observed that the base material added for reacting the metallic ions to the oxides made the change of the pH depending on its quantity to be added, and the condition of the reaction was preferable in a case that the pH was 8 to 8.5 representing a neutral. Also, it was observed that, if the pH was too higher or lower, the coating rate would be deteriorated or an uneven coating would be induced, resulting in a poor light property of the phosphor. For a final reaction of the metallic oxide, the powder coated and collected at a high temperature in a reaction furnace was heat treated. It was observed the heat treatment was effectively performed in a range of 350° C. to 500° C. to achieve the oxidization of the coated material. Also, it was observed that the time for the heat treatment was preferable in a range of 10 minutes to 120 minutes.

As described above, according to the present invention, there is provided a method of manufacturing a green phosphor Zn₂SiO₄:Mn for a plasma display panel, which is capable of improving a discharge property of the green phosphor and thus the plasma display panel.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

1. A phosphor for a plasma display panel, wherein the phosphor is formed by coating a metallic oxide having a high polarity to a surface of a green phosphor Zn₂SiO₄:Mn with a thickness of 10 nm to 0.5μm, a concentration of a metallic ion in the metallic oxide being in a range of 1 to 50 weight % with respect to the green phosphor.

2. The phosphor according to claim 1, wherein the metallic oxide with the high polarity is selected from a group consisting of magnesium oxide MgO, zinc oxide ZnO, europium oxide Eu₂O₃, lead oxide PbO, aluminum oxide. Al₂O₃, and a mixture of two or more the magnesium oxide MgO, the zinc oxide ZnO, the europium oxide Eu₂O₃, the lead oxide PbO and the aluminum oxide Al₂O₃.

3. A method of manufacturing a phosphor coated with a metallic oxide for use in a plasma display panel, comprising the steps of:
(1) manufacturing a precursor by mixing a metallic salt, a solvent and a green phosphor, the metallic salt being a metallic oxide with a high polarity;
(2) adjusting pH of the precursor in a range of 7 to 10 by adding a basic material to the precursor;
(3) homogeneously dispersing the precursor during the adjustment of the pH or after the adjustment; and
(4) filtering a solid material remaining after the step of dispersing and heating the filtered solid material at 100° C. to 600° C. for 10 minutes to 300 minutes.

4. The method according to claim 3, wherein the metallic salt used in the step of manufacturing the precursor is selected from a group consisting of a nitrate, an acetate, a sulphate or a chloride of magnesium; a nitrate, an acetate, a sulphate or a chloride of zinc; a nitrate, an acetate, a sulphate or a chloride of europium; a nitrate, an acetate, a sulphate or a chloride of an aluminum; a nitrate, an acetate, a sulphate or a chloride of lead; and a mixture of two or more the magnesium, the zinc, the aluminum and the lead.

5. The method according to claim 3, wherein the solvent used in the step of manufacturing the precursor is selected from a group consisting of a water, a lower alcohol of a carbon-number 1 to 3 and an organic solvent including benzene, toluene, acetone and hexane, and a mixture of two or more the water, the lower alcohol and the organic solvent.

6. The method according to claim 3, wherein the basic material used in the step of adjusting the pH is selected from a group consisting of an ammonia NH₄OH, an urea, a sodium hydroxide NaOH and a sodium hydrogen phosphate Na₂HPO₄, and a mixture of two or more the ammonia NH₄OH, the urea, the sodium hydroxide NaOH and the sodium hydrogen phosphate Na₂HPO₄.

7. The method according to claim 3, wherein the step of heating the filtered solid material is performed in a range of 350° C. to 500° C. for 10 minutes to 120 minutes.
